(19) United States
(12) Patent Application Publication
(10) Pub. No.: US 2010/0268583 A1
(43) Pub. Date: Oct. 21, 2010

(54) MOBILE INTERNET ACCESS WITH PROXY SUPPORT

(76) Inventor: Jan Backman, Karna (SE)

Correspondence Address: ERICSSON INC., 6300 LEGACY DRIVE, M/S EVR 1-C-11, PLANO, TX, 75024, US

(21) Appl. No.: 12/810,569

(22) PCT Filed: Dec. 28, 2007
(86) PCT No.: PCT/SE07/01175

§ 371 Date: Jun. 25, 2010

(51) Int. Cl. G06F 15/16; G06Q 30/00

(52) U.S. Cl. 705/14.4; 709/206

(57) ABSTRACT

The present invention is directed to a method, a node arrangement and a mobile node for registering a Care-of-Address on behalf of a Mobile Node at a Home Agent in a home network of said Mobile Node when the Mobile Node is connected to a foreign network. The method comprises the steps of: providing at least one advertisement message to said Mobile Node (710) from a network node arrangement (722) in the foreign network (724), which advertisement message identifies the node arrangement (722) as a Home Agent for said Mobile Node (710), and receiving a request for an IP-address from said Mobile Node (710) at said node arrangement (722) as a response to said advertisement message, and providing 0 an IP-address to said Mobile Node (710) from said node arrangement (722) as a response to the request, which IP-address is valid for the Mobile Node (710) at the foreign network (724), and registering a Care-of-Address from said node arrangement (722) on behalf of said Mobile Node (710) at the Home Agent (712) in the home network (714) of said Mobile Node 710.

### TECHNICAL FIELD

The invention described herein relates to communication between nodes in communication networks. Embodiments of the invention relate to management of network addresses for mobile nodes in communication networks. Particular embodiments of the invention relate to nodes in wireless networks.

### BACKGROUND OF THE INVENTION

Mobility in connection with communication networks is often a precondition. The ability to move within a network and/or between various networks is particularly desirable in connection with mobile wireless terminals, e.g. such as cell phones or such as laptops etc provided with WLAN functionality or similar. A similar mobility is often desired for other terminals, e.g. such as wired Personal Computers (PCs) or similar.

As is well known to those skilled in the art, a solution for providing mobility in connection with the Internet and similar networks has been provided by the Internet Engineering Task Force (IETF). To this end the IETF has standardized a communication protocol called Mobile IP, or simply MIP. Mobile IP allows mobile devices to move from one network to another while maintaining a permanent IP-address. The basic features of Mobile IP are e.g. described in the IETF specification RFC 3344. Updates are e.g. added in IETF specification RFC 4721 and further developments are e.g. described in the specification RFC 3775.

Mobile IP provides an efficient and scalable mechanism for roaming within the Internet and similar networks. Through the use of Mobile IP a node may change its point-of-attachment to the network without changing its IP-address. This allows the node to maintain transport and higher-layer connections while moving between networks. Mobile IP is most often found in wired and wireless environments where users need to carry their mobile devices (Mobile Nodes) across multiple networks that are in fact reached on different IP-addresses. Mobile IP may for example be used in roaming between overlapping wireless systems, for example between WiFi, WiMax and/or 3G telecommunication networks and similar.

FIG. 1 is a schematic illustration of an exemplifying and well known Mobile IP system 100, e.g. based on the IETF specification RFC 3344. As can be seen in FIG. 1 the system 100 comprises a Mobile Node 110, a Home Agent 112, a Foreign Agent 122 and a Correspondent Node 120. Various designs of the Mobile Node 110 (MN), the Home Agent 112 (HA), the Foreign Agent 122 (FA) and the Correspondent Node 120 (CN) are well known per se to those skilled in the art and there is no need for a detailed description. Nevertheless, a short background will be provided below.

As can be seen in FIG. 1 the MN 110 is arranged to operatively communicate with the HA 112 or the FA 122 via the home network 114 or the foreign network 124 respectively. In turn, the HA 112 and the FA 122 are arranged to communicate with each other via a communication network 130 (e.g. the Internet or similar). In addition, the HA 112 is arranged to operatively communicate with the CN 120 via said communication network 130. In particularly, the HA 112 and the FA 122 are arranged to operatively enable communication between the MN 110 and the CN 120 over the network 130, irrespective whether the MN is connected to the home network 112 or the foreign network 124.

The exemplifying MN 110 in FIG. 1 is a terminal, a host or a router or similar that changes its point of attachment from one network or sub-network to another without changing its IP-address with respect to nodes that may communicate with the MN 110. In this way the MN 110 can continue to communicate with other Internet nodes and similar at any location using its (constant) IP-address. Here, it is assumed that a link-layer connectivity to a point of attachment is available and that the MN 110 comprises suitable hardware and software, e.g. in the form of an interface that is suitable for utilizing the available link-layer connectivity, and a client that enables the MN 110 to access the network in question and nodes or similar that is available therein as is well known to those skilled in the art.

The exemplifying HA 112 in FIG. 1 is a router or similar connected to the home network 114 of the MN 110. The HA 112 serves as the anchor point for communication with the MN 110. In particular, the MN 112 tunnels data packets or similar for delivery to the MN 110 when the MN 110 is away from its home network 114. In the exemplifying system 100 shown in FIG. 1 the HA 112 tunnels packets received from the CN 120 and addressed to the MN 110 at its Home Address (HoA), by forwarding the packets to a Care-of-Address (CoA) via a tunnel 132 established between the HA 112 and the FA 122, which is the reachable point for the MN 110 in the foreign network 124. Such tunneling is well known to those skilled in the art.

The exemplifying FA 122 in FIG. 1 is preferably a router or similar that functions as the point of attachment for the MN 110 when the MN 110 roams to the foreign network 124. In other words, the FA 122 is preferably a router in the foreign network 124 visited by the MN 110, which router provides mobility services to the MN 110 while registered. The FA 122 de-tunnels and delivers the data packets to the MN 110 that were tunneled by the HA 112 of the MN 110. For data packets sent by the MN 110, the FA 122 may serve as a default router for registered Mobile Nodes (MNs).

The CN 120 is a peer or similar with which the MN 110 is communicating. The CN 120 may be mobile or stationary.

The following steps provide an exemplifying outline of the operation of the Mobile IP protocol in the exemplifying Mobile IP system 100 shown in FIG. 1.
a) The mobility agents (i.e. the FA 122 and the HA 112 enabling mobility for the MN 110) advertise their presence to the MN 110. As is well known, this can e.g. be done by means of Agent Advertisement messages or similar, which e.g. may comprise at least one Care-of-Address (CoA) and a flag indicating whether the mobility agent is a Home Agent or a Foreign Agent.
b) The MN 110 receives at least one of these advertisements and determines whether it is located on its home network 114 or on the foreign network 124.
c) If the MN 110 detects that it is located on the home network 114 it may operate without mobility services. If returning to its home network 114 from being registered elsewhere, the MN 110 deregisters with its HA 112 through the exchange of Registration Request and Registration Reply messages or similar.
d) If the MN 110 detects that it has moved to the foreign network 124 it registers with the FA 122 by sending a Registration Request message or similar, which includes the permanent IP-address (the HoA) for the MN 110 and the IP-address for the HA 112 of the MN 110. In turn, the FA 122 performs the registration process on behalf of the MN 110 by sending a Registration Request or similar containing the permanent IP-address for the MN 110 and the IP-address (the CoA) for the FA 122 to the HA 112. As indicated above, the CoA can be provided by the FA 122 in its advertisement messages (i.e. a foreign agent CoA) or by some external assignment mechanism such as DHCP or similar. The transportation of the MN 110 to the foreign network 124 is illustrated in FIG. 1 by a MN 110 with dashed lines at the home network 114 and a dashed arrow to the MN 110 with solid lines at the foreign network 124.
e) When the HA 112 receives the Registration Request message or similar from the FA 122 it updates its home list or similar by associating the CoA of the MN 110 with the HoA of the MN 110.
f) The HA 112 then sends an acknowledgement to the FA 122.
g) The FA 122 in turn updates its visitor list or similar by associating the HoA and/or the address for the HA 112 of the MN 110 with a media address for the MN 110 valid on the foreign network 124 and relays the reply to the MN 110.

The following steps provide an exemplifying outline of the service phase of the Mobile IP protocol in the exemplifying Mobile IP system 100 shown in FIG. 1.
1. When the CN 120 wants to communicate with the MN 110, it sends an IP packet addressed to the permanent IP-address (the HoA) of the MN 110.
2. The HA 112 then intercepts the packet and consults its home list or similar to find out whether the MN 110 is currently visiting any other network, e.g. finds out whether there is a CoA registered for the MN 110.
3. Assuming that the HA 112 encounters a CoA registered for the MN 110 it will construct a new IP header that contains the CoA of the MN 110 as the destination IP-address. The original IP packet comprising the HoA of the MN 110 is put into the payload of this IP packet. The HA 112 will then send a down-link packet to the CoA. This process of encapsulating one IP packet into the payload of another IP packet is known as IP-within-IP encapsulation, or tunneling. This has been illustrated in FIG. 1 by a tunnel 132 extending from the HA 112 to the FA 122.
4. When the encapsulated packet reaches the foreign network 124, the FA 122 decapsulates the packet and finds out the HoA of the MN 110. The FA 122 then consults its visitor list or similar to see if it has an entry for the MN 110.
5. If there is an entry for the MN 110 in the visitor list, the FA 122 retrieves the corresponding media address and relays the packet to the MN 110 via the foreign network 124.
6. When the MN 110 wants to send an up-link packet to the CN 120, it forwards the packet to the FA 122, which in turn relays the packet to the CN 120 using normal IP routing.

In contrast to the exemplifying network in FIG. 1, other networks may not have an explicitly designated FA or similar. Instead an Access Router (AR) or similar may be used for providing access for a mobile node to the network in question.

FIG. 2 is a schematic illustration of another exemplifying and well known Mobile IP system 200. The system 200 in FIG. 2 is substantially the same as the system 100 in FIG. 1. Hence, the same or similar reference numbers indicate the same or similar features. However, as can be seen in FIG. 2 the FA 122 in FIG. 1 has been replaced by an access router AR 222. Here, the foreign agent (FA) or similar can be perceived as located in the MN 210, a so called co-located FA. Moreover, the tunnel 132 in FIG. 1 has been replaced by the tunnel 232 extending all the way to the MN 210 in FIG. 2. The fact that the MN 210 serves as the endpoint of the tunnel 232 is illustrated in that the tunnel 232 continues from the AR 222 to the MN 110, instead of ending at the FA 122 as in FIG. 1. The well known Mobile IP system 200 in FIG. 2 will be elaborate in some detail below.

As schematically illustrated in FIG. 2, when the MN 210 enters the foreign network 124 comprising the access router 222 it obtains a co-located CoA. Typically, a co-located CoA is a local IP-address acquired by the MN 110 through some external means. The co-located CoA may e.g. be provided by the AR 222 or some other node or node arrangement in the foreign network 124, or it may be dynamically acquired as a temporary IP-address by the MN 110 through DHCP or similar. Once in possession of a collocated CoA the MN 210 (or the co-located FA) registers the co-located CoA with its HA 112 so as to create a tunnel 232 in the same or similar manner as described above with reference to the tunnel 132 in FIG. 1. In case a co-located CoA is used the MN 210 (or the co-located FA) serves as the endpoint of the tunnel 232 and it is therefore the MN 210 (or the co-located FA) that performs decapsulation of the packets or similar tunneled to it. In the reverse direction, data packets or similar sent by the MN 210 to the CN 120 may be delivered to the CN 120 using standard IP routing mechanisms in the same or similar manner as described above with reference to FIG. 1.

The structure and function of the Mobile IP systems 100, 200 are well known to those skilled in the art and they are e.g. described in the IETF specification RFC 3344 and its ancillary specifications and in similar documents from the IETF and others. Hence, there is no need for a more detailed description of the general and well known structure and function of the Mobile IP systems 100, 200. However, specific details associated with embodiments of the present invention related to Mobile IP and similar will be discussed later herein.

As described above, it is assumed that the MNs 110, 210 in the systems 100, 200 respectively have the well known Mobile IP capability to signal its location to the Home Agent 112 so as to maintain a permanent IP-address while the MNs 110, 210 move from one network to another. In other words, the MNs 110, 210 maintains a permanent IP-address with respect to the CN 120 or similar nodes that may communicate with the MN 110, 210. However, there are many IP devices that are not provided with Mobile IP capability.

To this end a proxy based Mobile IP solution has been proposed within the framework of the IETF. The proxy based Mobile IP solution utilizes a dedicated entity to provide mobility services for an unaltered and substantially mobility unaware IP device that has no or insufficient Mobile IP capability. In particular, the solution is based on an external node or similar acting as a proxy node that registers the location of the device at a Home Agent and maintains reachability while the device is on the network in question.

FIG. 3 is a schematic illustration of an exemplifying proxy based Mobile IP system 300 in which the proposed solution may be implemented. The system 300 in FIG. 3 is similar to the system 100 in FIG. 1 in that it includes the same or similar HA 112, home network 114, CN 120, foreign network 124 and communication network 130. However, in contrast to the MN 110 in FIG. 1, it is assumed that the MN 310 in FIG. 3 is a node that has the ability to physically access different networks 114, 124, but has no or insufficient Mobile IP capability. Instead it is assumed that a Mobility Proxy Agent (MPA) offers a proxy mobility service for the MN 310, e.g. by performing registration functions on behalf of the Mobile Node 310. The MPA may e.g. be arranged in an access point, a base station, an access gateway or a similar Access Router 322 (AR).

The following steps provide a basic outline of the operation of the proposed Proxy Mobile IP solution applied to the exemplifying system 300 shown in FIG. 3. The steps are schematically illustrated in FIG. 4.
1a) The Mobile Node 310 performs an establishment and access authentication and/or authorization with the Access Router (AR) 322 comprising the MPA.
1b) The AR/MPA 322 exchanges Authentication, Authorization and Accounting (AAA) messages with an AAA infrastructure (not shown in FIG. 3) in the communication network 130 or in the home network 134 or possibly even in the home network 114 to perform authentication and authorization of the Mobile Node 310. As is well known an AAA infrastructure is commonly a part of modern communication networks such as e.g. cellular 3G networks defined by standards provided from the 3rd Generation Partnership Project (3GPP) (see e.g. www.3GPP.org).
2) The MN 310 sends an Internet Protocol Control Protocol (IPCP) configuration request to the AR/MPA 322 in case of a Point-to-Point protocol (PPP) to request for an IPv4 address. In particular, if the Dynamic Host Configuration Protocol (DHCP) is used, the DHCP client in the MN 310 sends a DHCPDISCOVER message to the AR/MPA 322.
3) Triggered by step 2 the MPA in the AR/MPA 322 sends a Mobile IPv4 registration request (RRQ) to the HA 112 on behalf of the MN 310. Here, it is suggested that the RRQ contains a care-of address (CoA) for the AR/MPA 322.
4) The HA 112 registers the session for the MN 310, assigns a Home Address (HoA) and returns the HoA to the AR/MPA 322 in a Registration Reply (RRP).
5) The AR/MPA 322 responds back to the MN 310 to suggest the IPv4 address, which is the HoA provided by the HA 112. This happens in response to step 2. If DHCP was used at step 2, the AR/MPA 322 sends back a DHCPOFFER to the HA 112 with the IPv4 address for the MN 310 set to the received HoA.
6) At this step, regular IPCP/NCP procedures get completed and the IP stack of the MN 310 is ready to receive or send IP packets. If DHCP is used, the regular DHCPREQUEST and DHCPACK messages are exchanged and the IP stack of the MN 310 is configured with the assigned IPv4 address, i.e. the HoA mentioned above.

Hence, as can be seen in FIG. 3, a proxy tunnel 332 is established between the HA 112 and the AR/MPA 322 with the effect that data packets or similar sent from the CN 120 to the MN 310 will be tunneled (forwarded) by the HA 112 to the AR/MPA 322, which in turn forwards the data packets to the MN 310 at the HoA that has been previously assigned as described above.

However, the proposed solution described above displays several drawbacks, particularly when devices such as the MN 310 without proper Mobile IP capability operate in the same network and/or networks as devices such as the MN 110 or MN 210 with Mobile IP capability.

For example, FIG. 5 illustrates the exemplifying proxy Mobile IP system 300 in FIG. 3 wherein a MN 210 provided with Mobile IP capability enters the proxy based foreign network 324. Following steps 4-5 in the proposed solution, when the MN 210 enters the proxy based foreign network 324 the HA 112 will provide the AR/MPA 322 with the HoA of the MN 210, whereupon the AR/MPA 322 forwards the HoA to the MN 210. This is schematically illustrated in FIG. 5 by the arrow labeled “HoA” pointing at the schematic point of attachment for the MN 210 to the foreign network 324. Now, since the MN 210 is provide with Mobile IP capability it will recognize that it is not at its home network 114 and it will therefore treat the provided HoA as its new care-of address (CoA) and register the HoA with its HA 112 through the exchange of a Registration Request and Registration Reply message as previously described with reference to FIGS. 1 and 2. As a result data packets or similar sent from the CN 120 to the MN 210 will be forwarded by the HA 112 to the HoA in the home network 114, i.e. not to the MN 210 in the foreign network 324. This has been schematically illustrated in FIG. 5 by a thick arrow from the CN 120 to the HA 112 and a thick arrow from the HA 112 to the HoA in the home network 114. Hence, the data packets from the CN 120 will not reach the MN 210, since it is in fact currently connected to the foreign network 324.

In another example illustrated In FIG. 6 it is assumed that a MN 210 provided with Mobile IP capability is connected to its home network 114. The MN 210 at its home network 114 has been indicated by a solid rectangle. Now, when the MN 210 enters the proxy based foreign network 324—still being connected to its home network 114—the HA 112 will provide the AR/MPA 322 with the Home Address (HoA) of the Mobile Node 210, whereby the AR/MPA 322 provides the HoA to the MN 210 via the foreign network 324. This establishes a proxy tunnel 332 between the HA 112 and the AR/MPA 322 as previously described with reference to FIG. 3, and data packets or similar sent from the CN 120 to the MN 310 will now be tunneled to the MN 210 via the tunnel 332 and the AR/MPA 322. Hence, any communication from the CN 120 to the MN 210 at the home network 120 will be interrupted even though MN 210 is still connected to its home network 114. The interrupted communication is illustrated in FIG. 6 by a thick dashed line extending between the HA 112 and the MN 210 via the home network 114. An uncontrolled interruption of this kind is typically improper or even unacceptable. For example, the period for establishing the proxy tunnel 332 and a communication between the HA 112 and the MN 210 via the foreign network 324 will most likely be too long to be acceptable for many real time applications, e.g. such as ordinary conversations and video conversations etc. Moreover, there is typically no guarantee that the quality of service required for the interrupted communication in the home network 144 can be provided in the new foreign network 324, at least not within an acceptable period of time.

Hence, there is a need for an improved proxy based Mobile IP solution that mitigates or avoids one or several of the proposed proxy based Mobile IP solution discussed above.

### SUMMARY OF THE INVENTION

The present invention provides an improved proxy based Mobile IP solution, which has been accomplished according to a first embodiment of the invention directed to a network node arrangement arranged to be operatively connected to a foreign network for communicating with at least one Mobile Node, characterized in that said node arrangement is arranged to operatively provide at least one advertisement message to said Mobile Node, which advertisement message identifies said node arrangement as a Home Agent for said Mobile Node, and arranged to operatively receive a request for an IP-address from said Mobile Node as a response to said advertisement message, and arranged to operatively provide an IP-address to said mobile node as a response to the request, which IP-address is valid for the Mobile Node at the foreign network, and arranged to operatively register a Care-of-Address on behalf of said Mobile Node at another Home Agent in a home network of said Mobile Node.

A second embodiment of the invention is directed to a node arrangement comprising the features of the first embodiment and is characterized in that the node arrangement is arranged to operatively provide said advertisement message to said Mobile Node via a wired interface or a an air interface of the foreign network.

A third embodiment of the invention is directed to a node arrangement comprising the features of the first embodiment and is characterized in that the node arrangement is arranged to operatively receive communication from the Home Agent, and arranged to operatively forward said communication to the Mobile Node via the foreign network.

A fourth embodiment of the invention is directed to a node arrangement comprising the features of the first embodiment and is characterized in that said node arrangement comprises an Access Router (AR) arranged to operatively provide said advertisement, and receive said request for an IP-address, and provide said IP-address, and a Mobility Proxy Agent (MPA) arranged to operatively register said Care-of-Address on behalf of said Mobile Node.

A fifth embodiment of the invention is directed to a node arrangement comprising the features of the first embodiment and is characterized in that said node arrangement is arranged to be operatively connected to a communication network, and arranged to operatively register said Care-of-Address via said communication network.

In addition, the present invention provides an improved proxy based Mobile IP solution, which has been accomplished according to a first embodiment of the invention directed to a method for registering a Care-of-Address on behalf of a Mobile Node at a Home Agent in a home network of said Mobile Node when the Mobile Node is connected to a foreign network,

The method comprises the steps of:
providing at least one advertisement message to said Mobile Node from a network node arrangement in the foreign network, which advertisement message identifies the node arrangement as a Home Agent for said Mobile Node,
receiving a request for an IP-address from said Mobile Node at said node arrangement as a response to said advertisement message,
providing an IP-address to said Mobile Node from said node arrangement as a response to the request, which IP-address is valid for the Mobile Node at the foreign network, and
registering a Care-of-Address from said node arrangement on behalf of said Mobile Node at the Home Agent in the home network of said Mobile Node.

A seventh embodiment of the invention is directed to a method comprising the features of the sixth embodiment and is characterized in that said method comprises the steps of providing said advertisement message to said Mobile Node via a wired interface or a an air interface of the foreign network.

An eight embodiment of the invention is directed to a method comprising the features of the sixth embodiment and is characterized in that said method comprises the steps of:
receiving communication from the Home Agent at said node arrangement in the foreign network, and
forwarding said communication from said node arrangement to the Mobile Node.

A ninth embodiment of the invention is directed to a method comprising the features of the sixth embodiment and is characterized in that said method comprises the steps of:
using an Access Router (AR) for providing said advertisement, and receiving said request for an IP-address, and providing said IP-address, and
using a Mobility Proxy Agent (MPA) for registering said Care-of-Address on behalf of said Mobile Node.

A tenth embodiment of the invention is directed to a method comprising the features of the sixth embodiment and is characterized in that said method comprises the steps of:
connecting the node arrangement to a communication network,
registering said Care-of-Address via said communication network.

Moreover, the present invention provides an improved proxy based Mobile IP solution, which has been accomplished according to an eleventh embodiment of the invention directed to a Mobile Node arranged to be operatively connected to a network node arrangement in a foreign network, characterized in that said Mobile Node is arranged to operatively receive at least one advertisement message from said node arrangement, which advertisement message identifies said node arrangement as a Home Agent for said Mobile Node, and arranged to operatively transmit a request for an IP-address to said node arrangement as a response to said advertisement message, and arranged to operatively receive an IP-address from said node arrangement as a response to the request, which IP-address is valid for the Mobile Node at the foreign network, and arranged to operatively have a Care-of-Address registered by said node arrangement on behalf of said Mobile Node at another Home Agent in a home network of said Mobile Node.

A twelfth embodiment of the invention is directed to a Mobile Node comprising the features of the eleventh embodiment and is characterized in that said Mobile Node is arranged to operatively receive said advertisement message from said node arrangement via a wired interface or an air interface of the foreign network.

A thirteenth embodiment of the invention is directed to a Mobile Node comprising the features of the eleventh embodiment and is characterized in that said Mobile Node is arranged to operatively receive communication from the Home Agent via said node arrangement which is arranged to operatively forward said communication to the Mobile Node via the foreign network.

A fourteenth embodiment of the invention is directed to a Mobile Node comprising the features of the eleventh embodiment and is characterized in that said Mobile Node comprises at least a first interface arrangement for operatively communicating with said Home Agent via said home network, and at least a second interface arrangement for operatively communicating with said Home Agent via said foreign network.

A fifteenth embodiment of the invention is directed to a Mobile Node comprising the features of the fourteenth embodiment and is characterized in that said Mobile Node is arranged to operatively receive communication simultaneously from said Home Agent via said home network of said Mobile Node and via said node arrangement in said foreign network.

A sixteenth embodiment of the invention is directed to a Mobile Node comprising the features of the eleventh embodiment and is characterized in that said Mobile Node is arranged to operatively receive communication from said Home Agent via said home network on a first Home Address and via said node arrangement in said foreign network via a Foreign Address.

Further advantages of the present invention and embodiments thereof will appear from the following detailed description of embodiment the invention.

It should be emphasized that the term “comprises/comprising” or similar when used in this specification is taken to specify the presence of stated features, integers, steps or components or similar, but does not preclude the presence or addition of one or more other features, integers, steps, components or groups thereof or similar.

It should also be emphasised that the steps or similar of the methods defined in the appended claims may, without departing from the present invention, be performed in another order than the order in which they appear in the claims.

### BRIEF DESCRIPTION OF THE DRAWINGS

FIG. 1 is a schematic illustration an exemplifying and well known Mobile IP system 100,

FIG. 2 is a schematic illustration of another exemplifying and well known Mobile IP system 200,

FIG. 3 is a schematic illustration of a suggested known proxy Mobile IP system 300,

FIG. 4 is a schematic state diagram illustrating a basic outline of the operational steps of the suggested proxy Mobile IP solution system 300 in FIG. 3,

FIG. 5 is a schematic illustration of the proxy Mobile IP system 300 in FIG. 3 wherein a MN 210 with Mobile IP capability enters the proxy based foreign network 324,

FIG. 6 is another schematic illustration of the proxy Mobile IP system 300 in FIG. 3 wherein a MN 210 with Mobile IP capability is still connected to its home network 114 when it enters the proxy based foreign network 324,

FIG. 7 is a schematic illustration of an exemplifying proxy Mobile IP system 700 according to an embodiment of the present invention,

FIG. 8 is a schematic illustration of the relevant parts of the exemplifying Mobile IP Node 710 of the system 700 shown in FIG. 7,

FIG. 9 is a flowchart illustrating the operational steps of an embodiment of the present invention,

FIG. 10 is a schematic illustration of the proxy Mobile IP system 700 in FIG. 7 with the addition of further communication paths,

FIG. 11 is a schematic illustration of another exemplifying proxy Mobile IP system 800 based on the proxy Mobile IP system 700 in FIG. 7 but with another home network 814.

### DETAILED DESCRIPTION OF PREFERRED EMBODIMENTS

### Structure of a Mobile IP-System According to a First Embodiment of the Invention

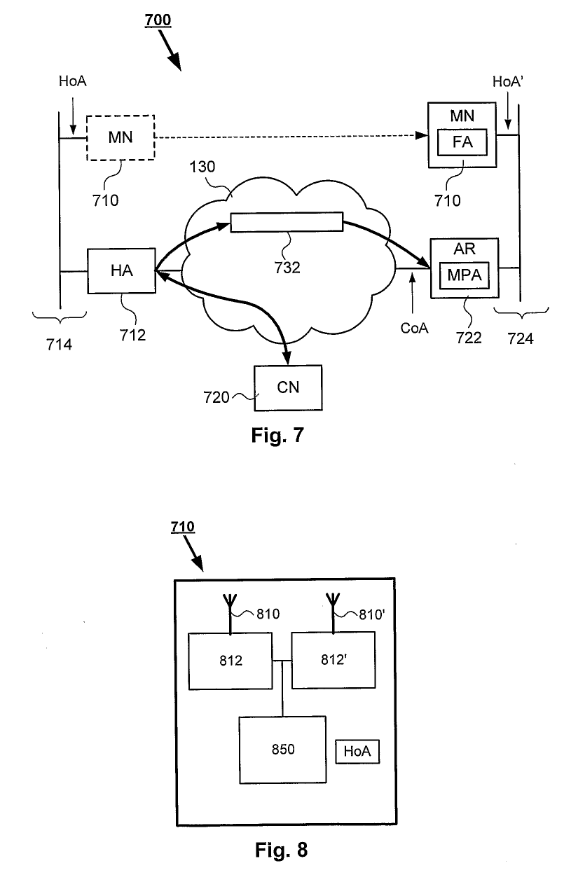

FIG. 7 is a schematic illustration of an exemplifying proxy Mobile IP system 700 according to an embodiment of the present invention. The proxy Mobile IP system 700 comprises a Mobile Node 710 (MN) with a co-located FA, a Home Agent 712 (HA), a home network 714, a Correspondent Node 720 (CN), an Access Router 722 (AR), a foreign network 724 and a communication network 130. Further, as can be seen in FIG. 7 the AR 722 comprises a Mobility Proxy Agent (MPA).

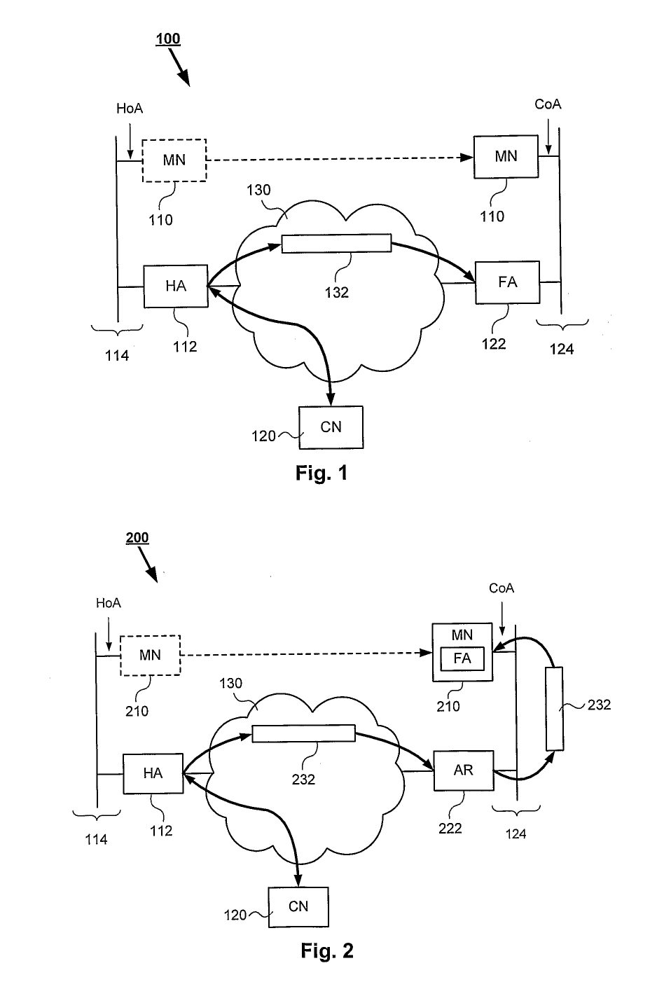

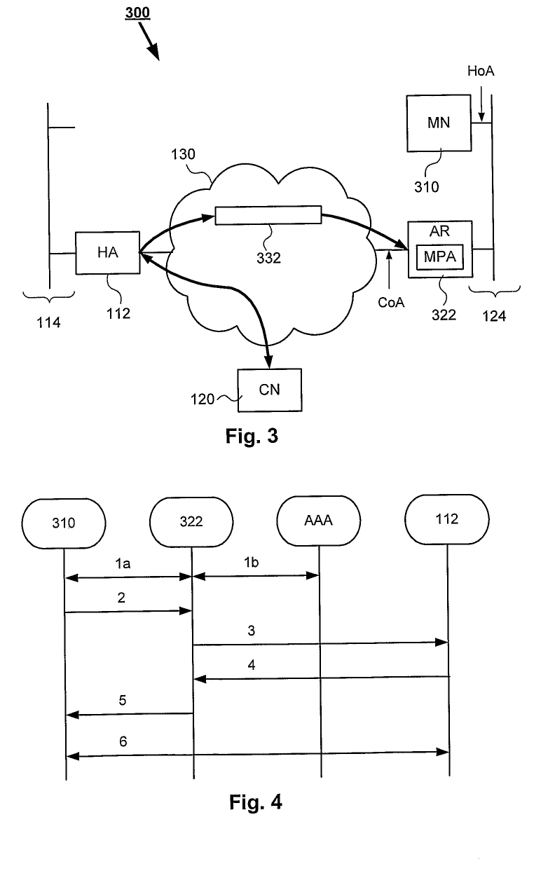

The exemplifying proxy Mobile IP system 700 is similar to the proxy Mobile IP systems 100, 200, 300 previously described with reference to FIGS. 1, 2 and particularly with reference to FIGS. 3 and 4. Hence, the mobility provided for the MN 710 in the exemplifying Mobile IP system 700 is preferably based on the IETF specification RFC 3344 or its successor or similar, e.g. such as the updates in the IETF specification RFC 4721 and/or such as the further developments IETF specification RFC 3775.

It follows that the MN 710, the HA 712, the home network 714, the CN 720, the AR/MPA 722, the foreign network 724 and the communication network 130 of the system 700 and various designs thereof are well known per se to those skilled in the art and there is no need for a detailed description of the ordinary features and functions of these nodes and networks etc. However, particular aspects related to embodiments of the present invention will be further discussed below.

It is preferred that the MN 710 in the system 700 is a Mobile IP Node, e.g. as previously described for the MN 210 with reference to FIG. 2. Hence the MN 710 may be a terminal, a host or a router or similar that changes its point of attachment from one network or sub-network to another without changing its IP-address with respect to nodes that may communicate with the MN 110. The MN 710 is preferably based on the IETF specification RFC 3344 and/or its updates or successor or similar, e.g. such as the updates in the IETF specification RFC 4721 and/or such as the further developments in the IETF specification RFC 3775.

Hence, it is assumed that the MN 710 has the Mobile IP capability to signal its location to the Home Agent 712 so as to maintain a permanent IP-address with respect to the CN 120 and other nodes that may communicate with the MN 710. To maintain a permanent IP-address it is preferred that the MN 710 is arranged to operatively register a Care-of-Address (CoA) or similar at the HA 712 or at an entity acting as the Home Agent (HA) for the MN 710. The CoA or similar may e.g. be registered in the same or similar manner as previously described with reference to FIG. 1 and/or FIG. 2.

Already here it should be clarified that the MN 710 accessing the AR/MPA 722 in the system 700 will not register a care-of address (CoA) or similar IP-address directly at the Home Agent 712 (HA), e.g. as previously described with reference to FIGS. 1 and/or 2. On the contrary, it is preferred that the CoA or similar is registered by the AR/MPA 722 on behalf of the MN 712. Hence, even if the MN 710 or similar would be without the Mobile IP capability to register a CoA or similar at the HA 712 as described with reference to FIGS. 1 and 2 it could nevertheless access the foreign network 724, whereupon the AR/MPA 722 would provide the mobility service by registering a CoA or similar at the HA 712 on behalf of the MN 710. Conversely, given that the MN 710 or similar is provided with the Mobile IP capability to register a CoA or similar with the HA 712 and given that the AR/MPA 722 acts as a Home Agent as will be further elaborated later, the MN 710 will recognise that it operates vis-à-vis a Home Agent in the foreign network 724 and it will therefore not attempt to register a CoA or similar at the HA 712, even though it has this capability. Instead, the MN 710 will operate without mobility services vis-à-vis the AR/MPA 722, which in turn registers a CoA or similar at the HA 712 on behalf of the MN 722.

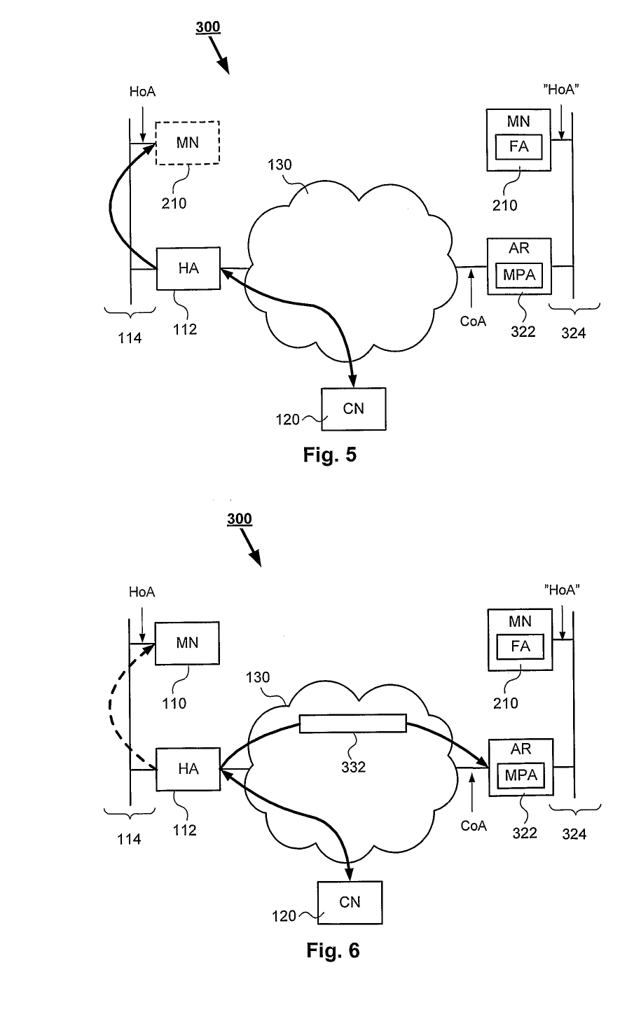

As the observant reader realises, the function of the AR/MPA 722 indicated above makes it possible to avoid situations leading to faulty addressing as previously discussed with reference to FIG. 5, since the HA 712 will in fact be provided with a CoA or similar for the MN 710 indicating that the MN 710 is in fact located at the foreign network 724. In addition, it is possible to avoid situations with interrupted communication as previously discussed with reference to FIG. 6, since the HA 712 may continue the communication with the MN 712 at its HoA in the home network 712 until communication has been safely established with the MN 710 at its CoA or similar in the foreign network 724. This will be elaborated in more detail later.

Before we proceed it should be added that the MN 710 preferably comprises a Home Address (HoA) that is valid at the home network 714 as the MN 710 moves between the home network 714 and the foreign network 724 or similar, or moves between other networks, e.g. such as between the foreign network 724 and another foreign network or similar. However, the HoA may be another identifier that enables the HA 712 to identify the MN 710. It should also be added that it is preferred that the MN 710 is arranged to operatively acquire an IP-address or similar from the visited foreign network 724 and/or the AR/MPA 722 or similar node or node arrangement in the foreign network 724.

Interior details of the MN 710 are shown in FIG. 8 providing a schematic illustration of the relevant parts of the MN 710. It is preferred that the MN 710 in FIG. 8 is provided with a first interface arrangement in the form of a first antenna 810 and a first radio circuit 812 being connected to each other for enabling radio communication with the home network 714 and the HA 712. It is preferred that the first radio circuit 812 is a WiFi radio or similar local radio and that the home network 714 is a local WiFi network or similar, e.g. based on the IEEE 802.11 standard or similar. Hence, in the exemplifying system 700 in FIG. 7 it is preferred that the MN 710 is arranged to operatively communicate with the home network 714 via a WiFi-based access, i.e. via a WiFi-based interface that is well known per se to a person skilled in the art. Further, as can be seen in FIG. 8, it is preferred that the radio circuit 812 is connected to a control unit 850 arranged within the MN 710 for controlling and supervising the general operation of the WiFi parts or similar of the MN 710. The control unit 850 may be implemented by means of hardware and/or software and it may comprise one or several hardware units and/or software modules, e.g. one or several processor units provided with or having access to the appropriate software and hardware required by the functions of the MN 710. The features and functions of a WiFi control unit as the control unit 850 or similar are well known to those skilled in the art and are e.g. described in the IEEE 802.11 and no further description is needed.

Moreover, it is preferred that the MN 710 in FIG. 8 is provided with a second interface arrangement in the form of a second antenna 810′ and a second radio circuit 812′ connected to each other for enabling radio communication with the foreign network 724 and the AR/MPA 722 connected thereto. It is preferred that that the second radio circuit 812′ is a WiMAX radio or similar regional radio and that the foreign network 724 is a regional WiMAX network or similar, e.g. based on the IEEE 802.20 standard or similar. Hence, in the exemplifying system 700 in FIG. 7 it is preferred that the MN 710 is arranged to operatively communicate with the foreign network 724 via a WiMAX-based access, i.e. via a WiMAX based interface that is well known per se to a person skilled in the art. Further, as can be seen in FIG. 8, it is preferred that the radio circuit 812′ is connected to the control unit 850 in the MN 710 for controlling and supervising the general operation of the WiMAX parts or similar of the MN 710. As already indicated above, the control unit 850 may be implemented by means of hardware and/or software and it may comprise one or several hardware units and/or software modules, e.g. one or several processor units provided with or having access to the appropriate software and hardware required by the functions of the MN 710. The features and functions of a WiMAX control unit as the control unit 850 or similar are well known to those skilled in the art of WiMAX technology and are e.g. described in the IEEE 802.20 and no further description is needed.

The attention is now directed to the exemplifying HA 712 in FIG. 7. The HA 712 is similar to the HA 112 as previously described with reference to FIG. 1. Hence, it is preferred that the HA 712 is a router or similar connected to the home network 714 of the MN 710. The exemplifying HA 712 serves as the Mobile IP anchor point for communication with the MN 710 according to the IETF specification RFC 3344 and/or its updates or successor or similar, e.g. such as the updates in the IETF specification RFC 4721 and/or such as the further developments in the IETF specification RFC 3775. In particularly, the HA 712 is arranged to operatively register a CoA or similar for the MN 710 so as to establish a tunnel for delivering data packets or similar to the MN 710 when the MN 710 is located at the foreign network 724. In the exemplifying system 700 shown in FIG. 7 the HA 712 tunnels packets received from the CN 120 to the MN 710 via a tunnel 732 established between the HA 712 and the AR/MPA 722, which is the reachable point for the MN 710 in the foreign network 724 as will be further elaborated below.

Before we proceed it should be added that the CN 120 may be any suitable node that is arranged to communicate with the HA 712 via the communication network 130. For example, the CN 120 may be a terminal, a host or a router or similar and it may even be a peer or similar with which the MN 710 is communicating. The CN 120 may be mobile or stationary.

The attention is now directed to the Access Router 722 (AR) of the system 700. It is preferred that the foreign network 724 comprises an AR 722 in the similar manner as previously described with reference to FIG. 3 and the AR 322. Hence, it is preferred that the AR 722 is a node or node arrangement or similar entity in the foreign network 724 that provides access to the foreign network 724 for mobile nodes such as the MN 710 and similar. The AR 722 may e.g. be an access point, a base station, an access gateway or a similar node or node arrangement providing access to the network 724.

In addition, it is preferred that the AR 724 comprises a Mobility Proxy Agent (MPA) or similar. It should be emphasised that in some embodiments of the invention the MPA or specific parts or functions thereof may not be directly comprised by the AR 724 but rather connected to or accessible by the AR 722. In either case, for the sake of simplicity the AR and the MPA will be jointly denoted AR/MPA 722 in the following.

In general, as is well known to those skilled in the art, a proxy server (e.g. such as the proxy-part in the AR/MPA 722) is typically a server or similar, e.g. a computer system and/or an application program that services the requests of its clients (e.g. such as the MN 710) by forwarding requests to other servers (e.g. such as the HA 712). The client connects to the proxy server and requests a service, such as a file, a connection, a web page or some other resource available from another second server or similar. The proxy server provides the resource by connecting to the second server and requesting the service on behalf of the client. A proxy server may alter the client's request or the response from the second server.

In view of the above it is preferred that the AR/MPA 722 offers a proxy mobility service for the MN 710. In particular, it is preferred that the access-part of the AR/MPA 722 is arranged to operatively provide access to the foreign network 724, whereas the proxy-part of the AR/MPA 722 is arranged to operatively provide mobility services on behalf of the MN 710. Hence, it is preferred that the proxy-part of the AR/MPA 722 is arranged to operatively register a CoA or a similar IP-address at the HA 712 on behalf of the MN 710 so as to establish a tunnel 732 between the HA 712 and the AR/MPA 722. It is also preferred that the proxy-part and/or the access-part of the AR/MPA 722 is arranged to operatively provide a foreign IP-address (HoA′) to the MN 710, which address can be used as the valid IP-address by the AR/MPA 722 with respect to the foreign network 724 and the MN 710. It is further preferred that the access-part of the AR/MPA 722 is arranged to operatively act as a Home Agent for the MN 710 in the foreign network 724.

### Function of a Mobile IP System According to an Embodiment of the Invention

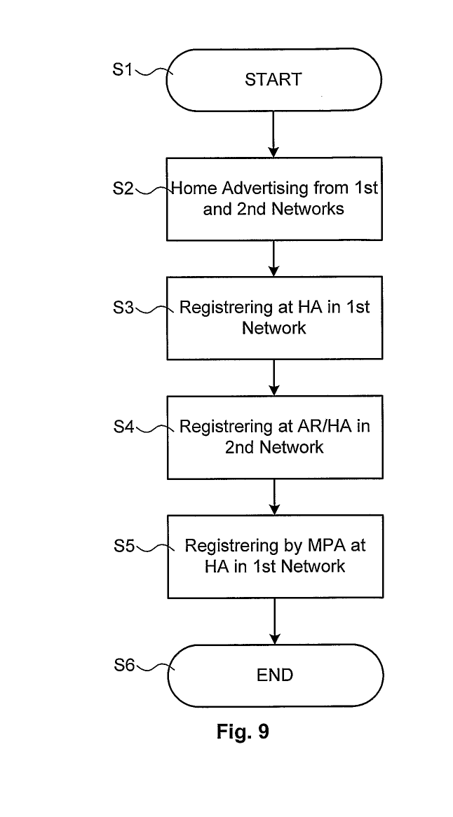

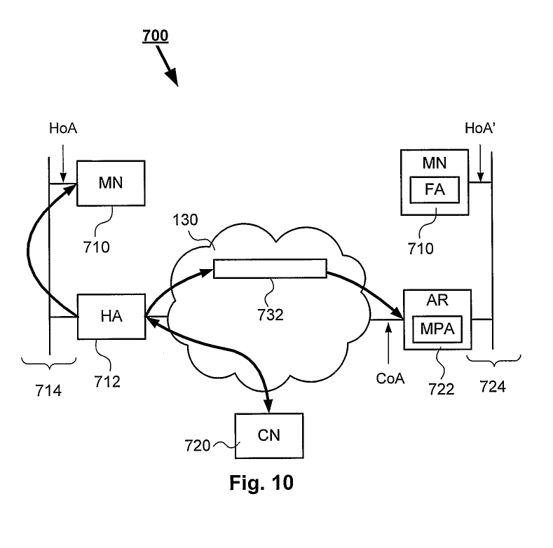

Exemplifying functions of the Mobile IP will now be described with reference to FIG. 9 showing a flowchart illustrating the operational steps of an embodiment of the present invention, and FIG. 10 showing a schematic illustration of the exemplifying proxy Mobile IP system 700 in FIG. 7 with the addition of further communication paths.

In a first step S1 it is preferred that the exemplifying proxy Mobile IP system 700 is activated so as to be operative. It is also preferred that the MN 710 is within range of at least the home network 714.

In a second step S2 it is preferred that the mobility agents—i.e. the AR/MPA 722 and the HA 712 enabling mobility for the MN 710 in the system 700—advertise their presence to the MN 710 via the air interfaces provided by the WiFi-based home network 714 and the WiMAX-based foreign network 724 respectively.

As is common in connection with Mobile IP it is preferred the HA 712 announces itself as the Home Agent (HA) for the MN 710 at the home network 714. In addition, it is preferred that the access-part of the AR/MPA 722 announces itself as the Home Agent (HA) for the MN 710 at the foreign network 724.

Announcing a node as a Home Agent for a Mobile Node is well known to those skilled in the art of Mobile IP and similar technologies and it is also described in the above mentioned specification RFC 3344, updated in e.g. the specification RFC 4721 and further developed as described in the specification RFC 3775. For example, as is well known, the announcements of the Home Agent may e.g. be performed via Agent Advertisement messages or similar messages transmitted from the HA 712 and AR/MPA 722 respectively. It is preferred that the announcements from the HA 712, AR/MPA 722 are set up by the operator of the networks 714, 724 respectively. In fact, the networks 714, 724 may have the same operator or there may be an agreement and/or cooperation between the operators of the networks 714, 724, which facilitates the setup of various nodes such as the HA 712 and the AR/MPA 722 and the distribution and/or allocation of IP-addresses as will be further discussed below.

In a third step S3 it is preferred that the MN 710 is located within the coverage area of the WiFi-based home network 714. Hence, the MN 710 will receive the Agent advertising messages or similar from the WiFi-based home network 714 and the HA 712.

Since the HA 712 announces itself as a Home Agent, the MN 710 will detect that it is accessing the home network 714. Hence, the MN 710 will register its presence at the home network 714, e.g. through the exchange of Registration Request and Registration Reply messages or similar with the HA 712. In particular, it is preferred that the MN 710 is registered at the HA 712 with a Home Address (HoA) that is the valid IP-address for the MN 710 at the home network 714. The HoA can e.g. be provided by the HA 712 and/or a similar node or node arrangement with in the home network 714. Hence, a communication path between the MN 710 and the HA 712 has been established via the home network 714 as indicated by the fat arrow extending from the HA 712 to the MN 710 in FIG. 10. Thus, data packets or similar addressed by the CN 720 to the MN 710 at its HoA can be forwarded by the HA 712 to the MN 710 at its HoA in the home network 714.

In the reverse direction, data packets or similar sent by the MN 710 to the CN 120 may e.g. be delivered to the CN 120 using standard IP routing mechanisms. For example, the data packets or similar may be delivered via the HA 712, which in turn forwards the data packets to the CN 120. Alternatively, the data packets or similar may e.g. be delivered directly to the CN 120. The reverse direction from the MN 710 to the CN 120 has not been explicitly indicated in FIG. 10.

The observant reader realizes that the MN 710 operates without mobility services vis-á-vis the home network 714 and the HA 714, i.e. without any CoA or similar. The HA 712 knows the location of the MN 710 due to its direct registration at the HA 712 and there is no need for the MN 710 to signal its location to the HA 712 by registering a CoA or similar as previously described with reference to e.g. FIG. 1 or 2.

In a fourth step S4 it is preferred that the MN 710 is also located within the coverage area of the WiMAX-based foreign network 724. Hence, the MN 710 will also receive the Agent advertising messages or similar from the WiMAX-based foreign network 724 and the AR/MPA 722.

Since it is preferred that the accessing-part of the AR/MPA 722 announces itself as a Home Agent the MN 710 will detect that it is accessing a home network. The MN 710 will therefore register its presence at the access-part of the AR/MPA 722 as being the Home Agent for the MN 710 at the foreign network 724. The registration at the AR/MPA 722 acting as a Home Agent for the MN 710 may e.g. be performed through the exchange of Registration Request and Registration Reply messages or similar as is well known per se by those skilled in the art.

In particular, it is preferred that the MN 710 is registered at the access-part of the AR/MPA 722 with a second Home Address (HoA′) that is the valid IP-address for the MN 710 at the foreign network 724. The HoA′ may also be denoted foreign HoA or foreign IP-address. The HoA′ may e.g. be provided by the AR/MPA 722 and/or a similar node or node arrangement within the foreign network 724, or by some external assignment mechanism such as DHCP or similar. Hence, a communication path between the MN 710 and the AR/MPA 722 has been established via the foreign network 724.

The observant reader realizes that the MN 710 operates without mobility services vis-á-vis the foreign network 724 and the AR/MPA 722, i.e. without any CoA or similar. The AR/MPA 722 announces itself as the Home Agent for the MN 710 at the foreign network 724 and the MN 710 will therefore register itself directly at the AR/MPA 722, which implies that the AR/MPA 722 knows the location of the MN 710. Hence, since the access-part of the AR/MPA 722 acts as a Home Agent there is no need for the MN 710 to signal its location by registering a CoA or similar as previously described with reference to e.g. FIG. 1 or 2. Instead it is preferred that the mobility services for the MN 710 is provided by the proxy-part of the AR/MPA 722 while the MN 710 is registered at the foreign network 722 as will be described below.

In a fifth step S5 it is preferred that once the MN 710 has been registered at the AR/MPA 722 with a HoA′ as described above the proxy-part of the AR/MPA 722 sends a registration request (RRQ) or similar to the HA 712 on behalf of the MN 710.

In a sixth step S6 it is preferred that the method is ended. However, this should not be understood so as to limiting the exemplifying method to a single performance of the steps therein.

For enabling the identification of the MN 710 in the RRQ or similar it is preferred that the RRQ contains the HoA of the MN 710 valid at the home network 714 and the HA 712, which HoA is preferably comprised by the MN 710 as previously described. However, the HoA of the MN 710 may be replaced by another identifier that enables the HA 712 to identify the MN 710 and/or associate the MN 710 with the received RRQ or similar. It is also preferred that the RRQ or similar contains a care-of address (CoA) for the AR/MPA 722, i.e. not a CoA for the MN 710 at the foreign network 724 as is otherwise common, c.f. the systems 100, 200 described above with reference to FIGS. 1 and 2. It is preferred that the RRQ or similar is acknowledged by the HA 712 sending an acknowledge message back to the proxy-part of the AR/MPA 722.

Knowing the CoA for the AR/MPA 722 and hence indirectly the HoA′ for the MN 710 at the foreign network 724 enables the HA 712 to forward data packets or similar sent to the MN 710 at its ordinary HoA in the home network 714 to the CoA for the AR/MPA 722. In turn, knowing the HoA′ for the MN 710 in the foreign network 724 enables the AR/MPA 722 to forward said data packets or similar to the MN 710 at the HoA′ in the foreign network 724.

Hence, as can be seen in FIG. 10, a proxy tunnel 732 is established between the HA 712 and the AR/MPA 722 with the effect that data packets or similar sent from the CN 120 to the MN 710 can be tunneled by the HA 712 to the AR/MPA 722, which in turn forwards said data packets to the MN 710 at the HoA′ in the foreign network 724.

In the reverse direction, data packets or similar sent by the MN 710 to the CN 120 may e.g. be delivered to the CN 120 using standard IP routing mechanisms. For example, the data packets or similar may be delivered via the AR/MPA 722, which in turn forwards the data packets to the CN 120. Alternatively, the data packets or similar may e.g. be delivered directly to the CN 120. The reverse direction from the MN 710 to the CN 120 has not been explicitly indicated in FIG. 9.

It should be clear from the steps S1-S5 above that the MN 710 accessing the AR/MPA 722 does not register a care-of address (CoA) or similar IP-address directly at the HA 712. On the contrary, the registering of a CoA or similar will be handled by the proxy-part of the AR/MPA 722 on behalf of the MN 712. Hence, even if the MN 710 or similar would be without the Mobile IP capability to register a CoA or similar at the HA 712 as described with reference to FIG. 3 it can nevertheless access the foreign network 724, whereupon the AR/MPA 722 will provide the mobility services by registering a CoA or similar at the HA 712 on behalf of the MN 710. Conversely, given that the MN 710 or similar is provided with the Mobile IP capability to register a CoA or similar with the HA 712 and given that the AR/MPA 722 acts as a Home Agent, the MN 710 will recognise that it operates vis-à-vis a Home Agent in the foreign network 724 and it will therefore not attempt to register a CoA or similar at the HA 712, even though it has this capability. Instead, the MN 710 will operate without mobility services vis-à-vis the AR/MPA 722, which in turn registers a CoA or similar at the HA 712 on behalf of the MN 722.

As previously indicated in connection with the description of the MN 710, the function of the AR/MPA 722 makes it possible to avoid situations leading to faulty addressing as previously discussed with reference to FIG. 5. In addition, it is also possible to avoid situations leading to interrupted communication as previously discussed with reference to FIG. 6, since the HA 712 may continue the communication with the MN 712 at its HoA in the home network 712 until communication has been safely established with the MN 710 at its CoA or similar in the foreign network 724. This is can be achieved due to the fact that the HA 712 has access to both the HoA registered in the HA 712 for the MN 710 at the home network 714 and the CoA registered in the HA 712 for the MN 710 at the foreign network 724. Hence, the HA 712 can be arranged to operatively select to continue the communication with the MN 710 at its HoA in the home network 712 until the communication has been safely established with the MN 710 at its CoA in the foreign network 724.

In fact, even if communication of data packets and similar with the MN 710 via the foreign network 724 has been safely established the HA 712 may nevertheless be arranged to continue routing the communication to the MN 710 at its HoA in the home network 714, at least for a period of time. The routing path may e.g. be selected depending on the quality of service (QoS) available in a specific routing path. Similarly, the HA 712 may be arranged to operatively route communication to the HoA and the CoA of the MN 710, e.g. so as to increase the total downlink capacity to the MN 710. Naturally, this may require that the MN 710 is arranged so as to combine the data packets or similar from the two routs. Such combining may e.g. be facilitated if the HA 712 or similar provides marks or similar to the data packets or similar in the communication so as to indicate the order in which they are supposed to be combined by the MN 710. The combining as such would then be easy for a person skilled in the art.

### Structure of a Mobile IP-System According to a Second Embodiment of the Invention

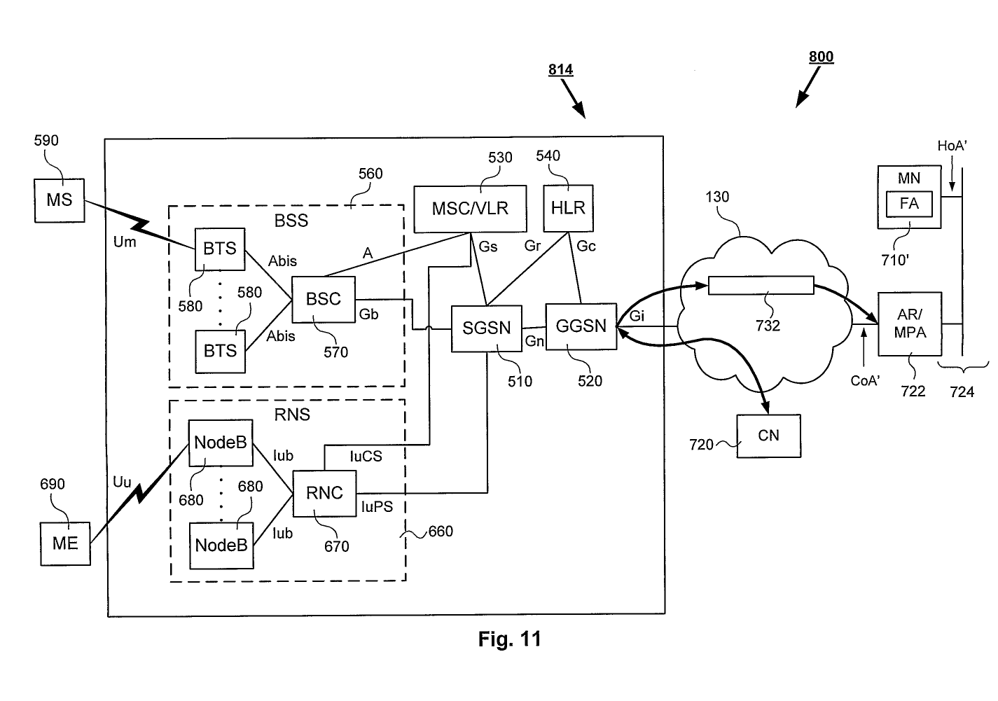

The attention is now directed to a second exemplifying proxy Mobile IP system 800 according to an embodiment of the invention as illustrated in FIG. 11. The system 800 is the same as previously discussed with reference to FIGS. 7, 8, 9 and 10. However, the WiFi-based home network 714 in has been replaced by an exemplifying telecommunication network 814 in the form of a General Packet Radio Service system (GPRS system) comprising various network elements and interfaces as shown in FIG. 11.

The structure and operation of a general GPRS system are well known to those skilled in the art and it needs no detailed explanation. Information about GPRS systems and similar systems as the UMTS can e.g. be found in the specifications released by the 3^{rd} Generation Partnership Project (3GPP), se e.g. www.3gpp.org. Nevertheless, a brief overview of an exemplifying GPRS network is given below. Before we proceed it should be emphasized that the home network 814 is by no way limited to a GRPS network or similar. On the contrary, the invention can be implemented in connection with most telecommunication systems of today, e.g. such as GSM, EDGE, CDMA, WCDMA and the HSDPA and similar.

The main Core Network (CN) elements in the GPRS network 800 are the Serving GPRS Support Node (SGSN) 510, the Gateway GPRS Support Node (GGSN) 520, and upgraded location registers such as the Visitor Location Register (VLR) 530 and the Home Location Register (HLR) 540. The SGSN 510 and the GGSN 520 may be connected directly and/or through intermediate routers and switches to form parts of the CN. In addition, it should be emphasized that a SGSN 510 and a GSGSN 520 may be fully or partly arranged in the same physical unit and/or as spatially separated equipments, e.g. equipments arranged at different geographical locations. The CN is used as the interface between a Radio Access Network (RAN)—as will be elaborated below—and various external data networks such as e.g. a Public Data Network (PDN). Here, as shown in FIG. 11, the PDN is the communication network 130. As previously described, the communication network 130 may e.g. be the Internet or similar.

The GGSN 520 operates as an interface between the CN and the various PDNs through the GPRS Gi-interface. At the other end the SGSN 510 operates as an interface between various RANs.

If the RAN is a GSM EDGE Radio Access Network (GERAN) the SGSN 510 interfaces through the GPRS Gb-interface. Typically, the GERAN comprises one or several Base station Sub-Systems (BSS) 560, which in turn comprises one or several Base Station Controllers (BSC) 570 at one end being connected to the SGSN 510 via said Gb-interface, and at the other end connected to a plurality of Base Transmission Stations (BTS) 580 via a GPRS Abis-interface. A BTS 580 is in turn serving one or several Mobile Stations (MS) 590 via a GPRS Um-interface, which is an air interface.

In addition, if the RAN is a Universal Terrestrial Radio Access Network (UTRAN) the SGSN 510 interfaces through the GPRS IuPS-interface. Typically, the UTRAN comprises one or several Radio Network Systems (RNS) 660, which in turn comprises one or several Radio Network Controllers (RNC) 670 at one end being connected to the SGSN 510 via said IuPS-interface, and at the other end connected to a plurality of NodeBs 680 via a GPRS Iub-interface. Each NodeB is in turn serving one or several Mobile Equipments (ME) via a GPRS Uu-interface, which is an air interface.

The SGSN 510 maintains signaling connections with the HLR 540 and a Mobile Switching Centre (MSC) and the VLR 530 through the GPRS Gs-interface and the GPRS Gr-interface respectively. The GGSN 520 maintains signaling connections with the HLR 540 through the GPRS Gc-interface. A BSC 570 maintains signaling with the MSCNLR 530 through the GPRS A-interface, whereas a RNC maintains signaling with the MSCNLR 530 through the GPRS IuCS-interface. The interconnection between the SGSN 510 and GGSN 520 are implemented through the GPRS Gn-interface.

The CN in GPRS can e.g. use the Internet Protocol (IP) as the protocol in the network layer. The protocols used in the transport layer can e.g. be the Internet User Datagram Protocol (UDP) for IP services and the Internet Transmission Control Protocol (TCP) for services which require delivery guarantee such as X.25 services.

The above description of the exemplifying GPRS network 814 corresponds in general to the 3GPP standard and particularly to the specifications in the 3GPP 28-series and 48-series regarding Signal Protocols RSS-CN.

As can be seen in FIG. 11, the exemplifying proxy Mobile IP system 800 is preferably provided with the same or at least similar AR/MPA 722 as previously described with reference to FIGS. 7, 9 and 10. However, regarding the previously discussed HA 712 it is preferred that the functions of the HA 712 are preformed by the GGSN 520 in the GPRS network 814 or a node arrangement in the network 814 comprising the GGSN 520 or being connected to the GGSN 520. For example, some functions of the previously discussed HA 712 may be performed by the GGSN 520 whereas other functions may be performed by other nodes in the network 814, which nodes are arranged to operatively communicate with the GGSN 520. In addition, the GGSN 520 may itself be distributed over several nodes in the network 814.

The MN 710′ in the Mobile IP system 800 is preferably provided with the Mobile IP capability to signal its location to a Home Agent in the same or similar manner as previously described with reference to the MN 710 in FIGS. 7 and 8 etc. It is also preferred that the MN710′ in the Mobile IP system 800 is provided with the ability to access the GPRS network 814 and the communication network 130 in the same or similar manner as an ME 690. The MN 710′ may e.g. be provided with additional radio circuit, antenna and control unit for communicating with the GPRS network 814 in the same or similar manner as previously described with reference to the MN 710 in FIG. 8, whereby the control unit supports the communication with all the networks 714, 724 and 814. This is well known per se to those skilled in the art and it needs no further description.

The present invention has now been described with reference to exemplifying embodiments. However, the invention is not limited to the embodiments described herein. On the contrary, the full extent of the invention is only determined by the scope of the appended claims.

1. A network node arrangement (722) arranged to be operatively connected to a foreign network (724) for communicating with at least one Mobile Node (710, 710′),
characterized in that said node arrangement (722) is:
arranged to operatively provide at least one advertisement message to said Mobile Node (710, 710′), which advertisement message identifies said node arrangement (722) as a Home Agent for said Mobile Node (710, 710′),
arranged to operatively receive a request for an IP-address from said Mobile Node (710, 710′) as a response to said advertisement message,
arranged to operatively provide an IP-address to said mobile node (710, 710′) as a response to the request, which IP-address is valid for the Mobile Node (710, 710′) at the foreign network (724), and
arranged to operatively register a Care-of-Address on behalf of said Mobile Node (710, 710′) at another Home Agent (712, 520) in a home network (714, 814) of said Mobile Node (710, 710′).

2. The node arrangement (722) according to claim 1,
characterized in that said node arrangement (722) is:
arranged to operatively provide said advertisement message to said Mobile Node (710) via a wired interface or an air interface of the foreign network (724).

3. The network node arrangement (722) according to claim 1,
characterized in that said node arrangement (722) is:
arranged to operatively receive communication from the Home Agent (712, 520), and
arranged to operatively forward said communication to the Mobile Node (710, 710′) via the foreign network (724).

4. The network node arrangement (722) according to claim 1,
characterized in that said node arrangement (722) comprises:
an Access Router (AR) arranged to operatively provide said advertisement, and receive said request for an IP-address, and provide said IP-address, and
a Mobility Proxy Agent (MPA) arranged to operatively register said Care-of-Address on behalf of said Mobile Node (710, 710′).

5. The network node arrangement (722) according to claim 1,
characterized in that said node arrangement is:
arranged to be operatively connected to a communication network (130), and
arranged to operatively register said Care-of-Address via said communication network (130).

6. A method for registering a Care-of-Address on behalf of a Mobile Node (710) at a Home Agent (712) in a home network (714) of said Mobile Node (710) when the Mobile Node is connected to a foreign network (724),
which method comprises the steps of:
providing at least one advertisement message to said Mobile Node (710) from a network node arrangement (722) in the foreign network (724), which advertisement message identifies the node arrangement (722) as a Home Agent for said Mobile Node (710),
receiving a request for an IP-address from said Mobile Node (710) at said node arrangement (722) as a response to said advertisement message,
providing an IP-address to said Mobile Node (710) from said node arrangement (722) as a response to the request, which IP-address is valid for the Mobile Node (710) at the foreign network (724), and
registering a Care-of-Address from said node arrangement (722) on behalf of said Mobile Node (710) at the Home Agent (712) in the home network (714) of said Mobile Node (710).

7. Then method according to claim 6
characterized in that said method comprises the steps of:
providing said advertisement message to said Mobile Node (710) via a wired interface or an air interface of the foreign network (724).

8. Then method according to claim 6
characterized in that said method comprises the steps of:
receiving communication from the Home Agent (712, 520) at said node arrangement (722) in the foreign network (724), and
forwarding said communication from said node arrangement (722) to the Mobile Node (710, 710′).

9. Then method according to claim 6
characterized in that said method comprises the steps of:
using an Access Router (AR) for providing said advertisement, and receiving said request for an IP-address, and providing said IP-address, and
using a Mobility Proxy Agent (MPA) for registering said Care-of-Address on behalf of said Mobile Node (710, 710′).

10. Then method according to claim 6
characterized in that said method comprises the steps of:
connecting the node arrangement (722) to a communication network (130),
registering said Care-of-Address via said communication network (130).

11. A Mobile Node (710, 710′) arranged to be operatively connected to a network node arrangement (722) in a foreign network (724),
characterized in that said Mobile Node (710, 710′) is:
arranged to operatively receive at least one advertisement message from said node arrangement (722), which advertisement message identifies said node arrangement (722) as a Home Agent for said Mobile Node (710, 710′),
arranged to operatively transmit a request for an IP-address to said node arrangement (722) as a response to said advertisement message,
arranged to operatively receive an IP-address from said node arrangement (722) as a response to the request, which IP-address is valid for the Mobile Node (710, 710′) at the foreign network (724), and
arranged to operatively have a Care-of-Address registered by said node arrangement (722) on behalf of said Mobile Node (710, 710′) at another Home Agent (712, 520) in a home network (714, 814) of said Mobile Node (710, 710′).

12. The Mobile Node (710, 710′) according to claim 11,
characterized in that said Mobile Node (710, 710′) is:
arranged to operatively receive said advertisement message from said node arrangement (722) via a wired interface or an air interface of the foreign network (724).

13. The Mobile Node (710, 710′) according to claim 11,
characterized in that said Mobile Node (710, 710′) is:
arranged to operatively receive communication from the Home Agent (712, 520) via said node arrangement (722) which is arranged to operatively forward said communication to the Mobile Node (710, 710′) via the foreign network (724).

14. The Mobile Node (710, 710′) according to claim 11,
characterized in that said Mobile Node (710, 710′) comprises:
at least a first interface arrangement (810, 812) for operatively communicating with said Home Agent via said home network (714), and at least a second interface arrangement (724) for operatively communicating with said Home Agent via said foreign network (724).

15. The Mobile Node (710, 710′) according to claim 14,
characterized in that said Mobile Node (710, 710′) is:
arranged to operatively receive communication simultaneously from said Home Agent (712, 520) via said home network (714, 814) of said Mobile Node (710, 710′) and via said node arrangement (722) in said foreign network (724).

16. The Mobile Node (710, 710′) according to claim 1,
characterized in that said Mobile Node (710, 710′) is:
arranged to operatively receive communication from said Home Agent (712, 520) via said home network (714, 814) on a first Home Address (HoA) and via said node arrangement (722) in said foreign network (724) via a Foreign Address (HoA′).
